(19) United States
(12) Patent Application Publication
(10) Pub. No.: US 2018/0179412 A1
(43) Pub. Date: Jun. 28, 2018

(54) Coated Substrates and Compositions for Coating Substrates

(71) Applicant: Landec Corporation, Santa Clara, CA (US)

(72) Inventors: Steven Bitler, Menlo Park, CA (US); Julian Schafer, Montara, CA (US)

(21) Appl. No.: 15/901,874

(22) Filed: Feb. 21, 2018

Related U.S. Application Data
(63) Continuation-in-part of application No. 15/247,943, filed on Aug. 26, 2016.
Application No. 15/247,943 is a continuation-in-part of application No. 15/687,371, filed on Aug. 25, 2017.
(60) Provisional application No. 62/461,302, filed on Feb. 21, 2017.

(51) Int. Cl. C09D 151/00

(52) U.S. Cl. CPC C09D 151/003

(57) ABSTRACT

Coated floors comprising
(1) a flooring substrate, and
(2) a solid coating of a Releasable SCC Polymer Composition which (i) is adjacent to the substrate, (ii) can be triggered by heat and (iii) comprises (a) a sidechain crystalline polymer (SCC polymer) which has an onset of melting temperature, T₀, which is higher than any temperature to which the substrate will be exposed during normal use and a peak melting temperature (Tp) which is less than any temperature which will damage the substrate, preferably a Tp of at most 120° C. and (b) a matrix polymer.

### CROSS-REFERENCE TO RELATED APPLICATIONS

This application claims priority from copending U.S. Provisional No. 62/461,302, filed 21 Feb. 2017, by Steven P Bitler and Julian Schafer, and is a continuation in part of
(1) copending International Application No. PCT/US 2016/048,878, filed 26 Aug. 2016, by Steven P Bitler and Julian Schafer, claiming priority from U.S. Provisional Application No. 62/461,302 claiming priority from U.S. Provisional No. 62/461,302 file 21 Feb. 2017,
(2) copending U.S. application Ser. No. 15/247,943, filed 26 Aug. 2016, by Steven P Bitler and Julian Schafer, claiming priority from U.S. Provisional Application No. 62/211,274 filed 28 Aug. 2015, by Steven P Bitler and Julian Schafer, and
(3) copending U.S. application Ser. No. 15/687,371, filed Aug. 25, 2017, by Steven P Bitler and Julian Schafer, claiming priority from U.S. Provisional 62/461,302, filed 21 Feb. 2017, by Steven P Bitler and Julian Schafer, and from U.S. Provisional No. 62,380,331, filed Aug. 26, 2016 by Steven P Bitler and Julian Schafer.
   The entire disclosure of each of those applications is incorporated herein by reference for all purposes.

### BACKGROUND OF THE INVENTION

It is well known to protect and enhance the appearance of substrates, e.g. floors and countertops, by the application of a surface coating. In many cases, the coating is formed by applying to the substrate a polymeric emulsion or solution which dries to a hard protective film.

The surface coating on the floors of commercial establishments needs to be replaced at regular intervals. Many commercial floor finishes are based on acrylate polymers which are cross-linked using metal ions. The replacement of such floor coatings requires the use of alkaline strippers with consequences which are well known to be highly undesirable. Other floor coatings have better wear resistance than acrylate polymers, but must be removed mechanically, e.g. by sanding, which creates dust and which can damage the flooring substrate.

Other surface coatings which may need to be removed are (i) coatings which were originally useful but which now need to be replaced and/or removed, e.g. labels, decals, wallpaper or paint, and (ii) coatings which were never desired, e.g. graffiti.

This invention, like the earlier applications incorporated by reference herein, describes compositions which (i) comprise a side chain crystalline polymer (abbreviated herein to “SCC polymer”), (ii) can be applied as a liquid to a substrate, for example a flooring substrate, and (iii) after application to the substrate, can be converted into a coating which is (a) solid, (b) does not prevent the use of the coated substrate in the range of temperatures at which the coated substrate is normally used, and preferably is not tacky in the temperature range 15-25° C., and (c) can be triggered by heat so that the coating can be removed. The compositions of this invention are different from those disclosed in the earlier provisional applications filed Aug. 28, 2015, U.S. non-provisional application Ser. No. 15/247,944, and International Application Nos. PCT US 2016/48,878 and PCT US 2016/49,117

The compositions of this invention are referred to herein as “Releasable SCC Polymer Compositions”, whether the composition is (i) a liquid which is ready to be applied, or has been applied, to a substrate, or (ii) a solid coating, or (iii) a solid coating which has been triggered by heat.

The term “is not tacky” is used herein to mean that the solid coating exhibits a tack value less than 25 g.cm/sec of force, measured in accordance with ASTM D2979 (see for example U.S. Pat. No. 5,387,450).

The term “can be triggered by heat” is used herein to mean that the solid coating of Releasable SCC Polymer Composition can be subjected to heating which converts the SCC polymer from a predominantly crystalline state to a partially or fully amorphous state, which enables the coating to be removed. In some cases, when the Releasable SCC Polymer Composition is triggered by heat, the SCC polymer becomes a viscous liquid or a flowing gel; in other cases, the SCC polymer softens but has little or no flow.

The term “sidechain crystalline polymer”, often abbreviated to SCC polymer or SCCP, is used to denote a polymer which contains a backbone and long side chains which (i) are attached to and extend from the backbone, and (ii) at temperatures below the melting point of the SCC polymer, can crystallize together to render the polymer predominantly crystalline.

The Releasable SCC Polymer Composition can comprise a single SCC polymer or two or more different SCC polymers. In many cases, the Releasable SCC Polymer Composition includes a matrix polymer in which the SCC polymer is dispersed.

A coating of the Releasable SCC Polymer Composition can be (i) an “exterior coating”, the term “exterior coating” being used to denote a coating which is exposed to the ambient atmosphere, or (ii) an “interior” coating, the term “interior coating” being used to denote a coating which is covered by one or more exterior coatings. The exterior coating or coatings can be composed of a conventional floor finish. The coating of the Releasable SCC Polymer Composition can be in direct contact with the substrate or can be separated from the substrate by one or more intermediate (“tie” or “primer”) coatings.

When the coating of the solid Releasable SCC Polymer Composition is triggered by heat, the SCC polymer is converted from a fully crystalline state to a partially or fully amorphous state, thus reducing the adhesion between the Releasable SCC Polymer Composition and any adjacent surface. This in turn makes it possible for at least part of the exterior coating to be removed.

It is preferred that the Releasable SCC Polymer Composition should be heated to a temperature which is greater than the onset of melting point of the SCC polymer (hereinafter abbreviated to To) and in many cases to a temperature at least as high as the peak melting temperature of the SCC polymer (hereinafter abbreviated to Tp). Particularly if the difference between the To and the Tp of the SCC polymer is large, it is preferable to heat the SCC polymer to a temperature substantially above To.

The conversion of the Releasable SCC Polymer Composition into discrete parts can be accomplished in any way. The discrete parts can be removed in any way.

### SUMMARY OF THE INVENTION

This invention discloses improvements to the Releasable SCC Polymer Compositions. Some of the improvements, as summarized in paragraphs (A)-(E) below, are also disclosed in U.S. Provisional application 62/380,331, filed Aug. 26, 2016, which is incorporated by reference herein. Additional information related to the application and removal of such compositions can be found in International Application No. PCT US 2016/049119, filed 26 Aug. 2016, which is incorporated by reference herein in its entirety.
(A) The improved Releasable SCC Polymer Compositions are preferably prepared by mixing together (i) a liquid emulsion of particles of the SCC polymer, (ii) a liquid emulsion of particles of the matrix polymer, and (iii) water, and optionally other water soluble ingredients. The size of the SCC polymer particles is greater than the size of the matrix polymer particles. The greater size of the SCC polymer particles reduces the relative surface area that has to be covered by the matrix polymer in the dried coating (in which the matrix polymer is no longer in the form of particles but is a continuous matrix) and promotes the formation of a continuous crack-free coating.

The preferred size for the SCC polymer particles is 70 -150 nm, for example 90-110 nm. However SCC polymer particles of lesser size, e.g. 40-80, or 40-60 nm, can be used; however, it is difficult to make SCC polymer particles having a size less than 50 nm by emulsion polymerization. In many cases, it is desirable for the solid coating to be transparent, and the use of SCC polymer particles having a size greater than 150 nm have an adverse effect on the transparency of the coating. SCC polymer particles having a size greater than 150 nm can be used when the solid coating can be opaque.

The preferred average size of the matrix polymer particles in the liquid emulsion is for example 50-80 or 60-70 nm. Even smaller sizes can be used, but it is difficult to make emulsions of the preferred matrix polymers, in particular the acrylate polymers, in which the particle size is less than 50 nm.

Preferred matrix polymer compositions are not so soft that they detract from the durability and wear resistance of floor finishes applied over them. Harder matrix polymers having MFFTs of 30-80° C. are often preferred but require the presence of the film-forming aids, such as solvents and/or plasticizers, to assist in the formation of a solid crack-free film at ambient temperatures.
(B) The SCC polymer particles in the liquid emulsion can be prepared by methods that result in particles having a greater ratio of surface area to weight than conventionally prepared spherical particles. The SCC polymer particles can be of any non-spherical shape. The particles can be grafted, partially coated, lobed or fused in structure.
(C) The SCC polymer particles may be prepared by polymerizing the SCC monomers in the presence of an emulsion of an amorphous polymer, for example a styrene-ethyl hexyl acrylate polymer. The size of the seed polymer particles is preferably less than 100 nm, particularly less than 70 nm, e.g. 40-60 nm. In one embodiment, the seed polymer is only a small amount, e.g. 4-10%, or 5-7% by weight of the completed particle. In another embodiment, the seed polymer is a greater percentage of the completed particle, e.g. 10-40%, or 20-30%; in which case, the completed particles are more likely to be grafted, lobed or fused in structure.
(D) The SCC polymer particles may have a core of the SCC polymer (optionally surrounding a small amount of an amorphous seed polymer) which is surrounded by an outermost layer or shell of an amorphous polymer. In this case, the polymer particles have two distinct phases so that, after film formation of the releasable SCC polymer composition, the amorphous phase may become continuous with one or more amorphous matrix polymers in which the SCC phase is dispersed as separate particles.
(E) When some or all of the particles comprise a portion composed of a SCC polymer and one or more portions composed of a non-SCC polymer, whether the non-SCC polymer portion(s) is (are) inside and/or outside the SCC polymer and/or in other parts of the particle, the non-SCC polymer may be chosen so as to improve its compatibility with and dispersal in the matrix polymer of the Releasable SCC Polymer Composition.

Particular aspects of the present invention are summarized below.

### First Aspect of the Invention.

In a first aspect this invention provides a coated floor comprising
(1) a flooring substrate, and
(2) a Releasable SCC Polymer Composition which (i) is in the form of a solid coating which is adjacent to (but not necessarily in direct contact with) the substrate (ii) is not tacky in the temperature range 15-25° C., (iii) can be triggered by heat, and (iv) comprises a sidechain crystalline polymer (SCC polymer) which has an onset of melting temperature, T₀, which is higher than any temperature to which the substrate will be exposed during normal use, and a peak melting temperature, Tp, which is less than any temperature which will damage the substrate, preferably a Tp of at most 120° C.,
   wherein the Releasable SCC Polymer Composition makes use of one or more of the improvements (A)-(E) set out above.

In many cases, the solid coating of the Releasable SCC Polymer Composition is covered by one or more coatings of a different polymeric composition which improves the wear and/or appearance characteristics of the coated floor

### Second Aspect of the Invention

In a second aspect, this invention provides a Releasable SCC Polymer Composition which comprises (1) an SCC polymer which has an onset of melting temperature, T₀, of at least 10° C., or at least 15° C., or at least 27° C. and a peak melting temperature (Tp) of at most 120° C. and (2) a matrix polymer in which the SCC polymer is dispersed, wherein the Releasable SCC Polymer Composition makes use of one or more of the improvements (A)-(D) set out above.

### DETAILED DESCRIPTION OF THE INVENTION

In the Summary of the Invention above and in the Detailed Description of the Invention, the Examples, and the Claims below, and in the attached drawings, reference is made to particular features (including method steps) of the invention. It is to be understood that the disclosure of the invention in this specification includes all appropriate combinations of such particular features. For example, where a particular feature is disclosed in the context of a particular aspect or embodiment of the invention, or a particular claim, that feature can also be used, to the extent appropriate, in combination with and/or in the context of other particular aspects and embodiments of the invention, and in the invention generally.

The term “comprises” and grammatical equivalents thereof are used herein to mean that other elements (i.e. components, ingredients, steps etc.) are optionally present. For example, a structure “comprising” (or “which comprises”) components A, B and C can contain only components A, B and C, or can contain not only components A, B and C but also one or more other components.

The term “consisting essentially of” and grammatical equivalents thereof is used herein to mean that other elements may be present which do not materially alter the disclosed invention.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this specification, a range is given as “(a first number) to (a second number)” or “(a first number)-(a second number)”, this means a range whose lower limit is the first number and whose upper limit is the second number. For example, “from 2 to 16” or “2-16” means a range whose lower limit is 2 and whose upper limit is 16.

The numbers given herein should be construed with the latitude appropriate to their context and expression.

The terms “a”, “an” and “the” before an item are used herein to mean that there can be a single such item or two or more such items, unless the context makes this impossible.

The term “plurality” is used herein to mean two or more.

In describing and claiming the invention below, the following abbreviations, definitions, and methods of measurement (in addition to those already given) are used.

Parts and percentages are by weight, unless otherwise noted.

Temperatures are in degrees centigrade, unless otherwise noted.

Particle sizes given herein are median particle sizes measured by a Horiba LA-960 laser light scattering particle size analyzer.

The viscosities given herein were measured at 20° C. using a Brookfield LVF viscometer with spindle #3 at 60 RPM. The abbreviation Tₒ is used to denote the onset of melting and the abbreviation Tₚ is used to denote the peak crystalline melting point, both measured by means of a differential scanning calorimeter (DSC) at a rate of 10° C./minute and on the first heating cycle. Tₒ and Tₚ are measured in the conventional way well known to those skilled in the art. Thus Tₚ is the temperature at the peak of the DSC curve, and Tₒ is the temperature at the intersection of the baseline of the DSC peak and the onset line, the onset line being defined as the tangent to the steepest part of the DSC curve below Tₚ.

The molecular weights given herein were measured by gel permeation chromatography using a Perkin-Elmer Series 200 Autosampler and Binary LC pump with 3 Phenomenex GPC columns in two Series 200Peltier Column Ovens followed by a Series 200a refractive index detector and ASTRA software.

The term “VCT tile” (a commercial acronym for vinyl composition tile) is used herein to denote a floor tile which is composed primarily of ground limestone, vinyl resin (typically a polymer of 95% vinyl chloride and 5% vinyl acetate) and plasticizer (typically one or more phthalate esters); ASTM F1066-04 sets out certain requirements for VCT tiles such as dimensional stability and impact and heat resistance.

### The SCC Polymers Used in This Invention.

The SCC polymers used in this invention have an onset of melting temperature, Tₒ, which is higher than any temperature to which the substrate will be exposed during normal use, and a peak melting temperature (Tp) which is less than any temperature which will damage the substrate, preferably a Tp of at most 120° C.

In various embodiments of the invention, the SCC polymer has one or any possible combination of one or more of the following characteristics:—
(a) the SCC polymer has a To of at least 10° C., or at least 15° C., or at least 27° C., or at least 35° C., or at least 40° C.
(b) the SCC polymer has a Tp of at most 80° C., preferably at most 60° C., particularly at most 50° C.,
(c) the SCC polymer has a Tp and a T₀, measured in degrees centigrade, such that the value of (Tₚ−T₀) is less than Tₚ^{0.7}, preferably less than 25° C., preferably less than 20° C., particularly less than 15° C.,
(d1) the SCC polymer has a weight average molecular weight of at most 100,000 Da, preferably at most 50,000 Da, particularly at most 20,000 Da, and in some applications less than 10,000 Da,
(d2) some or all of the SCC polymer is cross-linked and has an average molecular weight over 1 million or exists as a gel whose molecular weight is so high that it cannot be measured by chromatography methods.
(e) the SCC polymer has been prepared by an emulsion polymerization process, preferably an emulsion polymerization process which produces particles having a size of 0.07 to 0.5 μm, particularly 0.1 to 0.25 μm,
(f) the SCC polymer comprises units derived from one or more n-alkyl acrylates or methacrylates in proportions by weight such that the average length of the n-alkyl groups is 16-20, for example 16-18, carbon atoms. the n-alkyl groups for example containing 8-22 carbon atoms, and the polymer for example containing 90 to 98%, e.g. 94 to 97%, by weight of the units derived from one or more n-alkyl acrylates.
(g) the SCC polymer comprises 90-98%, e.g. 94-97%, by weight of units derived from octadecyl acrylate and hexadecyl acrylate, the ratio of octadecyl acrylate to hexadecyl acrylate units being for example 16 to 2.
(h) the SCC polymer contains, for example in amount greater than 1%, for example 1-4%, e.g. 2-4%, or 1-3%, or 1-2%, units derived from (i) a comonomer containing a carboxylic group, e.g. methacrylic acid, and/or (ii) a comonomer containing a hydroxyl group, e.g. hydroxyethyl acrylate, hydroxyethyl methacrylate hydroxypropyl acrylate or hydroxypropyl methacrylate, and/or (iii) one or more other polar monomers such as acrylamide, methacrylamide or other derivatives of acrylamide.
(i) the SCC polymer has a heat of fusion of at least 20 Joules/g,
   wherein the SCC Polymer makes use of one or more of the improvements (A)-(E) set out above.

The SCC polymer often also contains the residue of a chain transfer agent, e.g. n-dodecyl mercaptan or butyl mercaptopropionate or methyl benzyl alcohol, which was used during the polymerization in order to control the molecular weight of the polymer.

The monomers can be reacted together by random, stepwise or block copolymerization wherein the SCC polymer is present as a plurality of first blocks and the film-forming polymer is present as a plurality of second rblocks.

The SCC polymer preferably contains little or substantially no low molecular weight oligomers or unreacted monomers. For example, the polymer preferably contains less than 2000 ppm of unreacted monomers.

Other SCC polymers can be produced using monomers which are not acrylate or methacrylates, e.g. polymers derived from vinyl esters of fatty acids, copolymers of ethylene and/or 1-alkenes, and polymers derived from other long chain alkyl monomers, for example as described in the US patents incorporated by reference herein.

In some embodiments the SCC polymers used in this invention are produced by emulsion polymerization. The polymers prepared by emulsion polymerization preferably have a particle size of 0.07 to 0.5μ, particularly 0.1 to 0.25μ, particularly 0.1-0.15 μm. However, higher particle sizes, e.g. up to 1μ, can be used if the polymer is present in a formulation containing appropriate amounts of other ingredients to ensure film formation. The larger size SCC polymer particles may alternatively be created by mechanical emulsification of melted SCC polymers prepared by bulk or solution polymerization processes. When the SCC polymer is applied to the substrate as a solution in a solvent or is melt-applied, the particle size of the SCC polymer is less relevant.

SCC polymers are in themselves known. Publications describing SCC polymers include U.S. Pat. Nos. 4,830,855, 5,120,349, 5,156,911, 5,254,354 5,387,450, 5,412,035, 5,469,867, 5,665,822, 5,752,926, 5,783,302, 5,807,291, 5,826,584, 6,199,318 6,255,367, 6,376,032, 6,492,462, 6,540,984, 6,544,453, 6,831,116, 6,989,417, 7,101,928, 7,169,451, 7,175,632, 7,449,511, 7,182,951, 7,291,389 and 8,114,883; J. Poly. Sci. 60, 19 (1962), J. Poly. Sci, (Polymer Chemistry) 7, 3053 (1969), 9, 1835, 3349, 3351, 3367, 10, 1657, 3347, 18, 2197, 19, 1871, J. Poly. Sci, Poly-Physics Ed 18 2197 (1980), J. Poly. Sci, Macromol. Rev, 8, 117 (1974), Macromolecules 12, 94 (1979), 13, 12, 15, 18, 2141, 19, 611, JACS 75, 3326 (1953), 76; 6280, Polymer J 17, 991 (1985); and Poly. Sci USSR 21, 241 (1979). The entire disclosure of each of those United States Patents and publications is incorporated in this specification by reference.

### Preparation of the SCC Polymers.

Those skilled in the art of the SCC polymers are conversant with the known methods for preparing SCC polymers. Reference may be made, for example, to the patents and publications incorporated by reference, for example U.S. Pat. No. 6,540,984 and U.S. Pat. No. 7,175,832 describing emulsion polymerization methods. Those skilled in the art, having regard to their own knowledge and the disclosure in this specification, will have no difficulty in preparing SCC polymers which are useful in this invention.

### Releasable SCC Polymer Compositions Containing Additional Ingredients.

When the SCC polymer has been produced by emulsion polymerization, it is difficult to make the SCC polymer particles coalesce, when the SCC polymer is dried at temperatures less than To, to form a continuous and crack-free coating. To avoid or limit the need to dry the SCC polymer emulsion at an elevated temperature, the Releasable SCC Polymer Composition applied to the substrate preferably contains additional ingredients which make it easier to form a thin, continuous and crack-free coating containing the SCC polymer. The additional ingredients may include, but are not limited to, non-crystalline polymers, water, solvents, diluents, wetting agents, thickeners, plasticizers and/or other additives that aid in the application, spreading and film formation of the coating.

The choice of additional ingredients preferably takes into account the physical and chemical properties of the surface of the substrate on which the Releasable SCC Polymer Composition is to be formed and the physical and chemical properties of any other coating later applied over the Releasable SCC Polymer Composition.

One of the additional ingredients which remains in the final coating is a matrix polymer in which the SCC polymer is dispersed. The matrix polymer provides film-forming properties to the Releasable SCC Polymer Composition. The matrix polymer comprises one or more polymers, each of which is at least partially amorphous, and may be substantially amorphous, and which may be a film-forming polymer in the absence of plasticizers or coalescing solvents. However, the matrix polymer may require the addition of plasticizers and/or coalescing solvents to provide or enhance the film-forming properties of the matrix polymer at ambient temperatures.

In some embodiments, the matrix polymer is a styrene-acrylic polymer, or another acrylic polymer, the polymer containing 0-25%, e.g. 1-25%, or 0-20%, e.g. 1-20%, or 0-15%, e.g. 1-15%, or 0-5%, e.g. 1-5%, of units derived from (i) one or more monomers containing carboxylic groups, for example methacrylic acid and/or (ii) a comonomer containing a hydroxyl group, e.g. hydroxyethyl acrylate, hydroxyethyl methacrylate, hydroxypropyl Isle acrylate or hydroxypropyl methacrylate, and/or (iii) one or more other polar monomers such as acrylamide methacrylamide or other derivatives of acrylamide.

In some embodiments, the matrix polymer is a styrene-acrylic polymer, or another acrylic polymer, the polymer being present, in the liquid Releasable SCC Polymer Composition in the form of an emulsion. The styrene-acrylic polymer or other acrylic polymer can be a core shell styrene-acrylic polymer or another core shell acrylic polymer.

The matrix polymer can for example be (i) a polymer which is not cross-linked and which has a molecular weight of up to 100,000, or (ii) a cross-linked polymer which has a molecular weight of over 100,000 or a gel with an infinite molecular weight.

The matrix polymer can for example have (i) an average particle size of 0.05-0.2 μm, e.g. 0.05-0.10 μm and/or (ii) an acid monomer content of 0-20%, or 0.5%, e.g. 1-5% and/or (iiii) a pH of 2-10, or 5-9, or 2-6.

In some embodiments, the matrix polymer has an MFFT below 20° C. Examples of such matrix polymer include Raykote 1610 (50% NV, 7° C. MFFT), Raytech 22053 (40.9% NV, 2° C. MFFT) and Rayflex 610 (58% NV, 0° C. MFFT). The MFFT of a polymer can be measured by ASTM D2354.

In other embodiments, the matrix polymer has an MFFT greater than 20° C. Examples of such matrix polymer include Raykote 97126 (41.2 NV, 35° C. MFFT), Raykote 97126 (41.2% NV, 35° C. MFFT) and Raykote 95435 (45.2% NV, 39° C. MFFT).

In some embodiments, the Releasable SCC Polymer Composition contains (a) 10-60%, or 20-50%, or 20-40%, e.g. 15-30%, of the SCC polymer particles and (b) 40-90%, for example 60-80% or 45-70%, of the matrix polymer. However, the invention includes the possibility that the Releasable SCC Polymer Composition contains 1-99% of the SCC polymer.

Other additional ingredients which are optionally present in the Releasable SCC Polymer Composition include (i) water and/or other ingredients, e.g. solvents, which evaporate after the composition has been applied to, and dried on, the substrate, and which are not, therefore, present in the final coating, and (ii) one or more other ingredients which remain in the final coating. The additional ingredients can include (i) thickeners, to decrease the tendency of a low solids coating to crawl and retract from the edges of the substrate due to poor wetting, for example in amount 0.1-0.2% solids on the total formulation, e.g. Acrysol TT-935, Acrysol TT-615 and the other hydrophobically-modified alkali swellable emulsions, (ii) surface tension reducers, for example in amount 0.05-0.4% or 0.1-0.4% solids on the total formulation, e.g. Fluorad FC-4432, Fluorad FC-129, Capstone FS-60 and Zonyl FSO, (iii) wetting and anti-foaming agents, for example in amount 0.05-0.25% solids on the total formulation, e.g. Surfynol 104A, Surfynol 104PA and Surfynol 485W, (iv) water-soluble solvents to improve film spreading, substrate wetting and interfacial adhesion, for example in amount 1-5% of the composition as it is applied to the substrate, e.g. glycol ethers and alcohols, and (v) plasticizers or coalescent agents to improved film formation during drying at ambient temperature.

Thus, the composition, when it is ready to be applied to the substrate, preferably contains other ingredients including, but not limited to, one or more matrix polymers, water, one or more surfactants, and one or more cosolvents. The composition can also contain additional ingredients which remain in the solid coating of the Releasable SCC Polymer Coating, and which improve the compatibility between (i) the coating and the substrate to which the liquid Releasable SCC Polymer Composition is applied and/or (ii) an exterior coating which is applied on top of the Releasable SCC Polymer Composition.

In particular embodiments of the invention, the Releasable SCC Polymer Composition comprises a matrix polymer having one or any possible combination of two or more of the following optional characteristics:—.
(a) the matrix polymer has a minimum film forming temperature (MFFT) which is at most 20° C.,
(b) the matrix polymer has a minimum film forming temperature (MFFT) which is at least 20° C.
(c) the matrix polymer is miscible with water,
(d) the matrix polymer is an acrylic polymer or a styrene-acrylic polymer prepared by emulsion polymerization, for example a cross-linked styrene-ethylhexylacrylate-methacrylic acid polymer, a styrene-butylacrylate-methacrylic acid polymer, a styrene-butylacrylate-methylmethacrylate-methacrylic acid polymer, or an isobutyl methacrylate-methylmethacrylate-hydroxyethyl acrylate polymer,
(e) the matrix polymer is composed of particles which are smaller than the particles of the SCC polymer, and
(f) the matrix polymer particles, during the drying of the liquid Releasable SCC Polymer Composition forms a continuous phase in which the SCC polymer is dispersed in the form of particles.

### Additional Details of the Releasable SCC Polymer Composition and Other Coatings.

In some embodiments of the invention, the Releasable SCC Polymer Composition is in the form of a solid coating which has a thickness of less than 10 μm, preferably less than 5 μm, or less than 2 μm, e.g. less than 1 μm. There can be two or more solid coatings each of which is a Releasable SCC Polymer Composition. When there are two or more such coatings, they are preferably applied separately and optionally can be separated by one or more polymeric coatings which are not composed of a Releasable SCC Polymer Composition, for example a polymeric coating which is not a Releasable SCC Polymer Composition, for example does not contain an SCC polymer, or a polymeric composition suitable for use as a wear coating as described below.

In some embodiments of the invention, the solid coating of the Releasable SCC Polymer Composition directly contacts the flooring substrate. In other embodiments, it is separated from the flooring substrate by an intermediate (“tie” or “primer”) layer, for example an intermediate layer comprising a polymeric composition which is not a Releasable SCC Polymer Composition and which optionally does not include an SCC polymer. The tie layer can make it easier to form a coating of the Releasable SCC Polymer Composition on the substrate and/or to subsequently remove part or all of a solid coating of the Releasable SCC Polymer Coating.

Particularly if the surface of the substrate has a porous, matte or otherwise non-uniform and non-glossy surface, there is preferably a tie layer which is between the substrate and the solid coating of the Releasable SCC Polymer Composition. This can makes it easier to form a uniform coating of the Releasable SCC Polymer Composition, and/or can reduce the number of outer coats which need to be applied over the solid coating of the Releasable SCC Polymer Composition in order to achieve a satisfactory appearance. Preferably the tie layer has sufficient abrasion resistance to ensure that it remains in place after the Releasable SCC Polymer Composition has been removed. Polyurethane compositions have been found to be particularly useful as tie or base coats.

Exemplary tie layers include traditional floor finishes, including crosslinked and non-crosslinked coatings such as acrylic polymer (including uv-cured acrylic polymer), polyurethane (including uv-cured polyurethane and polyurethane that is not uv-cured), polyurea, epoxy polymer (including uv-cured epoxy polymer), polysiloxane, vinyl polymer, styrene-butadiene polymer, as well as factory-applied coatings, concrete treatments, penetrating sealers, densifiers and other suitable coatings and treatments known to those skilled in the art. A tie layer may have a dry weight coating thickness of about 0.01 mil to about 100 mil.

In many embodiments of the invention, there is an exterior coating on top of the solid coating of the Releasable SCC Polymer Composition, for example an exterior coating which comprises one or more coatings of a commercially available flooring finish. The wear coating can for example be a coating formed from a coating composition as disclosed in U.S. Pat. No. 5,977,228 (Mauer), International Publication W0 1999/000459 or International Publication W0 2012/162641. The entire content of each of those publications is incorporated herein by reference for all purposes.

When there is more than one coating on the substrate, the coatings may have the same or different compositions.

### The Substrates Used in This Invention.

The substrate which carries the Releasable SCC Polymer Composition can be of any kind, but the invention is particularly useful when the substrate is a fixed floor surface or a substrate, for example a VCT tile or linoleum, which can be secured to a fixed substrate to provide a fixed floor surface.

In one embodiment of the invention, the substrate is a vinyl composition tile (VCT). Such tiles are well known and are composed primarily of ground limestone, vinyl resin (typically a polymer of 95% vinyl chloride and 5% vinyl acetate) and plasticizer (typically one or more phthalate esters); ASTM F1066-04 sets out certain requirements for VCTs such as dimensional stability and impact and heat resistance.

VCTs are frequently supplied with an upper surface coating of a thin (about 0.2 mil thick) acrylic lacquer sealer. Often, after the tiles have been secured to the rigid substrate, they are given three or four coatings of a conventional acrylic VCT finish, in order to produce a desirable glossy and wear-resistant surface.

The Releasable SCC Polymer Composition can be formed directly on a VCT, whether or not the VCT has a surface coating of an acrylic lacquer sealer. After the Releasable SCC Polymer Composition has been formed, one or more coats, e.g. 3-6 coats, of a conventional floor finish can optionally be applied so that the finished floor has desired durability and appearance.

### Exemplary Formulations.

Exemplary formulations of the invention are set out below. The formulations contain Vectra, which is a commercially available floor finish containing 19% solids; the solids are believed to be composed of amorphous styrene-acrylic polymer.

Each of the formulations contains, in addition to the listed ingredients, (1) about 12-15% by weight, based on the weight of the amorphous polymer, of tributoxyethyl phosphate, which is a plasticizer leveling aid.

### Formulation #1.

Formulation #1 contains the following ingredients: —

| | |
|---|---|
| 40.98 g | Water |
| 1.17 g | Carbitol DE (diethylene glycol ethyl ether) |
| 0.44 g | KP-140 |
| 2.00 g | Fluorosurfactant, 1% |
| 38.60 g | Vectra (19% solids) |
| 16.81 g | Polymer D |

Polymer D is a two stage SCC polymer whose preparation is described below.

### Formulation# 2.

Formulation #2 contains the following ingredients:—

| | |
|---|---|
| 45.91 g | Water |
| 1.88 g | Carbitol DE |
| 0.71 g | KP-140 |
| 2.00 g | Fluorosurfactant, 1% |
| 29.30 g | Vectra |
| 20.20 g | Polymer E |

Polymer E is a two stage SCC polymer whose preparation is described below.

### Formulation #3.

Formulation #3 contains the following ingredients.

| | |
|---|---|
| 55.65 g | Water |
| 3.16 g | Carbitol DE |
| 1.19 g | KP-140 |
| 2.00 g | Fluorosurfactant, 1% |
| 12.40 g | Vectra |
| 25.60 g | Polymer F |

Polymer F is a two stage SCC polymer whose preparation is described below.

### SCC Polymer Components.

The two-stage polymers used in the formulations above make use, as a starting material, of a composition which comprises (i) 42.9% of a single stage SCC polymer, polymer B, which contains 95% of an SCC polymer and about 5% of an amorphous polymer, (ii) 46.4% water, (iii) 9.4% of 1-propanol, and (iv) 1.3% of an anionic/non-ionic surfactant blend. Polymer B was obtained by the polymerization of a mixture of 83.3% stearyl acrylate, 13.7% cetyl acrylate, 2% methacrylic acid, 1.9% dodecyl mercaptan, and 2.1% a styrene-acrylic seed polymer (containing 60% styrene and 40% 2-ethyl hexyl acrylate).

### Preparation of Polymer D.

Polymer D is a two stage SCC polymer having a particle size of about 81 nm, a peak melting temperature of about 46.8° C. and an average molecular weight of about 274,900. The ingredients used for its preparation are

| | |
|---|---|
| water | 47.8% |
| 1-propanol | 6.6% |
| anionic/non-ionic surfactant blend | 1.5% |
| polymer ingredients as listed below | 44.1% |
| [polymer B | 65.5% |
| amorphous polymer | 34.5% |
| ingredients for amorphous polymer | |
| isobutylmethacrylate | 66.1% |
| methylmethacrylate | 21.0% |
| styrene | 8.1% |
| methacrylic acid | 3.3% |
| methacryloxypropyl trimethoxysilane | 0.5% |
| 2-acrylamido-2-methylpropane sulfonic acid | 1.0% |

### Preparation of Polymer E.

Polymer E is a two stage SCC polymer having a particle size of about 100 nm, a peak melting temperature of about 46.0° C. and an average molecular weight of about 350,600. The ingredients used for its preparation are

| | |
|---|---|
| water | 48.2% |
| 1-propanol | 5.1% |
| anionic/non-ionic surfactant blend | 1.5% |
| polymer ingredients listed below | 45.2% |
| [polymer B | 65.5% |
| amorphous polymer (ingredients listed below) | 34.5% |
| isobutylmethacrylate | 66.4% |
| methylmethacrylate | 21.1% |
| styrene | 8.2% |
| methacrylic acid | 3.4% |
| methacryloxypropyl trimethoxysilane | 0.5% |
| 2-acrylamido-2-methylpropane sulfonic acid | 0.4%] |

### Preparation of Polymer F.

Polymer F is a two stage SCC polymer having a particle size of about 130 nm, a peak melting temperature of about 46.5° C. and an average molecular weight of about 169,000. The ingredients used for its preparation are

| | |
|---|---|
| water | 6.7% |
| 1-propanol | 3.9% |
| anionic/non-ionic surfactant blend | 1.6% |
| polymer ingredients listed below | 45.2% |
| [polymer B | 37.5% |
| amorphous polymer (ingredients listed below) | 62.5% |
| n-butylacrylate | 28.0% |
| methylmethacrylate | 16.0% |
| styrene | 46.0% |
| methacrylic acid | 10.0%] |

Additional information follows.

### SCC Emulsion Coatings:

Emulsion polymers prepared from polymerization of n-alkyl acrylates, especially where the side chain contains 14-20 carbon atoms, provide a useful means to thermally control the adhesive and cohesive strength of strength of coatings prepared from them. For instance, homopolymers of stearyl (C18) acrylate are waxy, brittle and glassy at room temperature and remain so unless heated to the characteristic thermal transition of the crystalline side chains at 55° C. In the form of an emulsion polymer, evaporation of the water does not lead to film formation unless heated because the polymer particles will not flow or stick together in their crystalline state. Even with the addition of co-solvents, commonly used as film formation aids in coatings made from conventional emulsion polymers, this behavior remains largely unaffected because crystalline polymers have very low solubility in even the most aggressive solvents. For some applications, where an SCC emulsion coating is heated immediately before, during or after application to a surface, a coherent film can be produced but it remains extremely fragile and susceptible to abrasion or impact damage once cooled below its transition temperature and, without substantial modification, has little or no commercial value.

The mechanical properties of an SCC polymer can be improved by modification of the polymer composition, incorporating such low Tg monomers as butyl acrylate, ethylene or vinyl 2-ethylhexanoate. These monomers, where present at levels needed to improve coating properties will, at the same time, interrupt the crystalline character of the polymer where the polymerization process is random, and thus, largely eliminate the useful sharp thermal transition characteristic of the SCC polymer. In theory, block polymerization is one approach to the creation of polymers that contain separate crystalline and amorphous domains in order to provide improved mechanical and properties, however this is exceedingly difficult to accomplish with an emulsion polymerization process.

Blending two distinct emulsion polymers to create a coating with more desirable film properties is one commercial approach commonly used in the paint business where a single polymer does not perform well enough for a particular purpose. An experienced formulator of paints can assemble an additive package that will help to optimize the film properties of a product prepared from blending two or more emulsion polymers. For the purpose of a thermally responsive floor coating, SCCP emulsions were blended in various proportions with commercial styrene-acrylic floor finish products. These mixtures, where the SCCP is present at less than 50%, will usually dry to form a continuous film where the somewhat incompatible and un-coalesced SCCP particles become dispersed as in an amorphous polymer matrix when the coating mixture dries. As expected, the cohesive strength of such a mixed polymer film is substantially reduced by the presence of the SCCP but the thermal response is retained even though diluted in proportion to concentration.

By way of example, an SCCP emulsion with 100 nm median particle size, a Tm of 45° C. and Mw of 35,000 was prepared from a blend of C16 and C18 acrylates combined with 2% methacrylic acid and 0.5% dodecyl mercaptan using a seeded polymerization process starting with 5% of a 50 nm styrene-acrylic seed. When this SCCP emulsion was mixed at 5% into a commercial floor finish (Vectra) and 4 coats applied to VCT, the resulting finish suffered only marginally in scratch resistance compared to the un-modified finish but, when heated to 50° C., the film was only slightly softened and could not be removed from the floor unless substantial abrasive force was applied. Modified with 10% SCC, the finish would not meet a satisfactory commercial level of scratch resistance and still could not be easily removed when heated. At 20% modification, scratch resistance was poor but the film could be removed more readily with heat and scrubbing. At 30% modification in the first coat of four coats of Vectra, the resulting coating could be removed easily with heat and scrubbing but the abrasion resistance was very poor. At 20% modification in the first coat of 4 coats, abrasion resistance was better but not commercially acceptable and the coating construct could no longer be removed with heat and scrubbing. When the first or “trigger” coat contained, instead, 30% SCCP emulsion blended with an amorphous acrylic emulsion with a Tg>50° C., the scratch resistance improved somewhat but heat-activated removal suffered. If the SCCP has higher Mw, especially without mercaptan, thermally activated removal is no longer viable. If the SCCP has lower Mw, such as 15,000 -20,000, removability is slightly improved but scratch resistance suffers. It appears that the presence of sufficient un-modified SCCP in the trigger layer to facilitate heat activated removal changed its physical character so much that the scratch resistance of the subsequent finish coats was no longer acceptable.

In order to make an SCCP for a trigger coat with good release that does not excessively compromise the scratch resistance and adhesion of subsequent floor finish coats, it is desirable to more completely embed the SCCP in a hard amorphous matrix that is a component of the polymerization process rather than simply cold-blending two polymers. One such approach is to polymerize the SCC monomers in the presence of a “support resin” which commonly takes the form of an ammonia-neutralized acrylic or styrene-acrylic emulsion polymer containing 20% or more methacrylic acid. The resulting two part emulsion polymer trigger mixture, SCC and amorphous, benefits from the film formation properties of the acid functional amorphous polymer and is less detrimental to the scratch resistance of floor finishes applied over it (compared to a cold-blended trigger). However, such coatings do not have a completely satisfactory scratch resistance, probably because the SCCP is still not well encapsulated and interferes with the adhesion of floor finishes applied over it.

Nonetheless, such coatings may be useful in applications where a high level of scratch resistance is not required, such as in a strippable adhesive coating, a temporary anti-graffiti coating or a removable protective finish for automobiles or machinery. Use of an amorphous “support resin” for polymerization of SCCP is particularly useful because the amorphous polymer provides benefits in film formation, durability, adhesion and stability which properties may be deficient in the SCCP alone. In particular, where the support resin has a Tg close to the Tm of the SCCP, particularly where the Tg and Tm transitions are less than 10° C. apart, there can be a synergy between the two polymer domains that increases the thermal response providing better release because heating above the conjoined transition temperatures and reduces adhesion when heated even more than for either polymer alone.

A second approach for preparation of an improved SCCP emulsion is a 2-stage polymerization process where the first stage is for example a 60-90 nm, e.g. 75-80 nm, SCCP emulsion and the second stage is formed from a hard, amorphous monomer composition, especially with a Tg>40° C., e.g. a Tg>45° C. This 2-stage emulsion polymer, where the amorphous 2^{nd} stage comprises at least 30%, preferably at least 40%, of the total polymer, shows improved scratch resistance when formulated into trigger coats where the SCCP content of the trigger coat is as least 10% and as much as 60% of the coating polymers. At low SCCP levels in the trigger coat, especially below 30%, scratch resistance is better. At high SCCP levels, especially above 30%, thermal release is better.

With 2-stage emulsion polymers, the finished particles would ideally have a core-shell morphology where the 2^{nd} stage comprises the shell and, thus, expresses its physical characteristics in a more dominant way in the coating and at interfaces with other surfaces. For the purposes of a triggered floor coating, at least partial encapsulation, preferably full encapsulation, of the SCCP inside a shell of amorphous polymer whose composition can provide important coating properties such as film formation, good adhesion to VCT, cohesive strength and hardness sufficient to resist abrasion and compatibility with commercial floor finishes is desirable.

Core-shell morphology, however, is not always the result of a 2-stage polymerization process. For example, the 2^{nd} stage can merely mix with the first stage and form separate domains within and/or without the first stage, and thus fail to provide even partial encapsulation of the SCC polymer. Incomplete encapsulation of the SCC polymer can be desirable so that, when the coating is triggered by heat, the SCC polymer can migrate or flow to an interface in order to reduce adhesion between layers sufficient to promote removal of a floor coating.

Our experience with 2-stage emulsion polymers in which the first stage is an SCCP has shown that ratio between 1^{st} and 2^{nd} stage compositions is an important factor in the performance of the finished polymers used for floor finish applications. In order to assure at least partial encapsulation of an SCCP 1^{st} stage particle, the 2^{nd} stage polymer preferably provides at least 35%, e.g. at least 40%, of the total particle. Excessive encapsulation of the SCCP may reduce its ability to provide triggering of the coating. For this reason, the second stage polymer preferably provides at most 65%, particularly at least 60%, e.g. at least 55%, of the two stage polymer. Good results have been obtained when the amorphous 2^{nd} stage comprises at least 40% of the particle and the SCCP comprises no more than 60% of the particle.

We have formulated 2-stage SCCP-amorphous emulsion polymers with sufficient amorphous content and appropriate composition to produce crack-free and continuous film coatings at ambient temperatures well below the Tm of the SCCP. We have found, however, that such a coating at, for instance, 35% SCCP, is more susceptible to scratching and abrasion than another coating made from a mixture of the 2-stage SCCP polymer combined with a second, amorphous emulsion polymer with no SCCP content to average 35% SCCP in the blended polymer coating. This is particularly evident where the amorphous polymer particles are smaller in size than the 2-stage SCCP particles such that, during air-drying of the mixed coating, the smaller amorphous particles can coalesce combined with the outer layers of the larger 2-stage polymer to form a continuous amorphous matrix in the triggered floor coating.

For example, in one of the compositions tested, a 2-stage SCCP emulsion had an average particle size of 100 nm, an average Mw of 350,460 and a Tm of 46° C. It was made from 48% of an SCCP seed emulsion (79 nm average particle size, average Mw of 33,380 and Tm of 48° C.) onto which was polymerized a 52% 2^{nd} stage amorphous acrylic monomer mixture. The 2-stage polymer was formulated with Vectra, a commercial floor finish, (particle size 60 nm) at a ratio to yield 30% net SCCP at 15% NV solids. One coat of this trigger coating was applied to a cleaned black VCT, dried for one hour and then coated sequentially three additional coats of Vectra, allowing an hour to dry between coats. After 24 hours, the coating was found to have satisfactory scratch resistance. After 7 days, an identical coated tile was triggered for coating removal and it was found that the coating could be removed

Generally, when mixing trigger coating from a 2-stage SCC emulsion with an amorphous binder or matrix polymer emulsion, the ratio of the two emulsions used depends on three factors: namely (1) the % SCCP in the 2-stage polymer, (2) the final % SCCP in the trigger coating, and (3) the relative particle sizes of the two emulsions. If, for instance, we want a final trigger SCCP of 35% (solids basis) and the SCCP emulsion contains 40% SCCP (solids basis), then the amorphous matrix emulsion would preferably comprise about ⅛ of the total polymer mass and the 2-stage polymer about ⅞ of the polymer mass. Where the average particle size of the 2-stage polymer is 120 nm and the average particle size of the matrix polymer is 65 nm, the relative surface area provided by the two emulsions is about 80% (2-stage) and about 20% (matrix).

With the same relative particle sizes, but starting with an SCCP emulsion containing 50% SCCP and targeting a final trigger SCCP of 30%, then the amorphous matrix emulsion would preferably comprise 40% of the polymer mass and the 2-stage polymer the remaining 60%. In this case, the relative surface area contributions would be 45% (2-stage) and about 55% (matrix). In this case, the packing of the particles would be more efficient and the matrix polymer would wield a greater influence on the overall physical film properties of the dried coating compared to the previous example. Our experimental work with SCCP and matrix emulsions has a better combination of scratch resistance and thermal release when generally in the range of these two examples, for example the relative surface area provided by the two emulsions is 40-85, preferably 45-80, percent (2-stage) and 60-15, preferably 55-20, percent matrix.

### SUMMARY CONCLUSIONS

1) Un-modified SCCP emulsions provide thermally activated softening when blended into emulsion floor coatings at 10-20% level sufficient to permit removal by wet or dry scrubbing when triggered by heating. However, the presence of this much SCCP reduces the scratch and abrasion resistance to a level which is unsatisfactory for some commercial applications. At 2-5% modification, the scratch resistance is acceptable for many purposes, but removal by heat and abrasion is too difficult for some commercial applications.
2) Un-modified SCCP emulsions, when blended at 30-40% level in a floor finish coating to create trigger coat applied underneath multiple coats of floor finish, provide thermally activated loss of adhesion that aids removal by wet or dry scrubbing. Again, the presence of this much un-modified SCCP renders reduces the scratch and abrasion resistance of the installed coating system to a level which is unsatisfactory for some commercial applications.
3) Un-modified SCCP emulsions, when blended at 30-40% in a trigger coating also containing a harder and/or more crosslinked emulsion polymer and applied underneath multiple coats of a commercial floor finish, performs better for scratch resistance than when blended with a commercial floor finish but the scratch resistance remains unsatisfactory for some commercial applications.
4) Concentration of the SCCP in a single trigger layer applied to VCT prior to application of a commercial floor finish provides for a better balance of thermal release and room temperature scratch resistance than by simple blending of SCCP emulsion into a floor finish.
5) Increasing the level of SCCP in a floor finish installation, whether added to the finish or installed in a trigger layer, simultaneously improves thermal release and decreases scratch and abrasion resistance.
6) Reducing the Mw of the SCCP (from 100 k to 30 k) in a floor finish installation improves the thermal release of the installation, particularly when applied in a trigger coating, but decreases scratch resistance.
7) Modification of the SCCP by polymerization in the presence of an amorphous acrylic polymer emulsion as a means to achieve at least partial encapsulation of the SCCP domains in a triggered floor coating, compared to cold blending of two emulsions, provides for a moderate improvement in scratch and abrasion resistance but still not sufficiently for some commercial applications.
8) Modification of the SCCP by polymerization in the presence of an amorphous acrylic polymer with Tg that is close to the Tm of the SCCP, increases the thermal release characteristics in a triggered floor coating. This synergistic effect is most pronounced when the amorphous polymer has reduced molecular weight (from 350 k to 50 k).
9) Modification of SCCP emulsion particles as a 1^{st} stage to seed the polymerization of an amorphous 2^{nd} stage to create composite particles where the two polymer compositions are in distinctly separate domains, ideally as a core-shell morphology, and used in a separate trigger coat further improves the scratch resistance of the floor finish installation compared to unmodified SCCP while retaining a thermal response that remains proportionate to the % SCCP in the trigger coat.
10) Among the 2-stage SCCP emulsions, the balance between scratch resistance and thermal response is governed, in part, by the ratio of SCC to amorphous domains in the 2-stage emulsion. Over a range of 35% to 70% SCC in the 2-stage polymer, the best balance of performance, scratch resistance vs removability, occurs in the narrower range of 40-50% SCC when used in trigger coatings that are in the range of net 30-40% SCC.
11) Among the 2 stage SCCP emulsions, the balance of properties is affected by the Mw weight of each of the staged polymer compositions. Removability is better at lower Mw and scratch resistance better at higher Mw. For a 1^{st} stage SCCP with Mw of 33k, the Mw of the 2^{nd} stage more strongly affects the scratch resistance than it does removability. The best scratch resistance has been achieved with 2-stage polymers that use a slightly crosslinked 2^{nd} stage which is harder with Tg in the 60-65° C. range. The best removability has been seen with 2-stage polymers that use a 2^{nd} stage with Tg 44-46° C. and without crosslinking.
12) Among the 2-stage SCCP emulsions, the preferred particles are in the 90-130 nm diameter range. Larger particles do not offer as good transparency in a floor finish installation and smaller particles are much less likely to achieve the more desirable core-shell morphology.
13) Among the amorphous matrix polymers, the preferred particles are in the 60-80 nm diameter range, preferably 10-40 nm smaller in diameter than the SCCP emulsions so as to improve film formation and encapsulation of the SCC and by creating a continuous matrix, better dominate the film properties of the composite trigger coat in which they play an important role.
14) Among the amorphous matrix polymers, in addition to excellent film formation, the degree of hardness as measured by a higher Tg is most important. Higher Tg matrix polymers are more difficult to coalesce without the aid of plasticizers and co-solvents to aid film formation without cracking upon evaporation of water at room temperature.
15) Among the amorphous matrix polymers, it is also possible to achieve a better balance of hardness and film formation by utilizing a 2-stage or core-shell structure. Particles with a lower Tg, say 40-45° C. and, perhaps somewhat reduced molecular weight, in the first stage or core combined with a higher Tg, say 60-65° C., composition in the 2^{nd} stage are more likely to express good hardness while requiring less plasticizer and co-solvent to achieve film formation.
16) Among the amorphous matrix polymers, finding a monomer composition that is more compatible with the composition of the floor finish with which it will be installed is an important factor. For a very hard, highly zinc-crosslinked styrene-acrylic floor finish, a hard styrene-acrylic matrix may be preferred. For a more flexible, well-plasticized acrylic floor finish, less hardness is required of the matrix polymer to achieve compatibility and optimize scratch resistance.

1. A coated floor comprising
(1) a flooring substrate, and
(2) a solid coating of a Releasable SCC Polymer Composition which (i) is adjacent to the substrate, (ii) can be triggered by heat and (iii) comprises (a) a sidechain crystalline polymer (SCC polymer) which has an onset of melting temperature, T₀, which is higher than any temperature to which the substrate will be exposed during normal use and a peak melting temperature (Tp) which is less than any temperature which will damage the substrate, preferably a Tp of at most 120° C. and (b) a matrix polymer,
wherein the Releasable SCC Polymer Composition makes use of one or more of the improvements (A)-(E) set out above.

2. A coated floor according to claim 1 wherein the SCC polymer has one or more of the following characteristics
(a) the SCC polymer has a To of at least 10° C., or at least 15° C., or at least 27° C., or at least 35° C., or at least 40° C.,
(b) the SCC polymer has a Tp of at most 80° C., preferably at most 60° C., particularly al most 50° C.,
(c) the SCC polymer has a Tp and a T₀, measured in degrees centigrade, such that the value of (Tₚ−T₀) is less than Tₚ^{0.7}, preferably less than 25° C., preferably less than 20° C., particularly less than 15° C.,
(d1) the SCC polymer has a weight average molecular weight of at most 100,000 Da, preferably at most 50,000 Da, particularly at most 20,000 Da, and in some applications less than 10,000 Da,
(d2) some or all of the SCC polymer is cross-linked and has an average molecular weight over 1 million or exists as a gel whose molecular weight is so high that it cannot be measured by chromatography methods,
(e) the SCC polymer has been prepared by an emulsion polymerization process which produces particles having a size of 0.07 to 0.5 μm, particularly 0.1 to 0.25 μm,
(f) the SCC polymer comprises units derived from one or more n-alkyl acrylates or methacrylates in proportions by weight such that the average length of the n-alkyl groups is 16-20, for example 16-18, carbon atoms, the n-alkyl groups for example containing 8-22 carbon atoms, and the polymer for example containing 90 to 98%, e.g. 94 to 97%, by weight of the units derived from one or more n-alkyl acrylates.
(g) the SCC polymer comprises 90-98%, e.g. 94-97%, by weight of units derived from octadecyl acrylate and hexadecyl acrylate, the ratio of octadecyl acrylate to hexadecyl acrylate units being for example 16 to 2.
(h) the SCC polymer contains, for example in amount greater than 1%, for example 1-4%, e.g. 2-4%, or 1-3%, or 1-2%, units derived from (i) a comonomer containing a carboxylic group, e.g. methacrylic acid, and/or (ii) a comonomer containing a hydroxyl group, e.g. hydroxyethyl acrylate, hydroxyethyl methacrylate hydroxypropyl acrylate or hydroxypropyl methacrylate and/or (iii) one or more other polar monomers such as acrylamide, methacrylamide or other derivatives of acrylamide,
(i) the SCC polymer has a heat of fusion of at least 20 Joules/g,
and wherein the matrix polymer has one or more of the following characteristics:
(a) the matrix polymer has a minimum film forming temperature (MFFT) which is at most 20° C.,
(b) the matrix polymer has a minimum film forming temperature (MFFT) which is at least 20° C.
(c) the matrix polymer is miscible with water,
(d) the matrix polymer is an acrylic or styrene-acrylic polymer prepared by emulsion polymerization, for example a cross-linked styrene-ethyl hexylacrylate-methacrylic acid polymer, a styrene-butylacrylate-methacrylic acid polymer, a styrene-butylacrylate-methylmethacrylate-methacrylic acid polymer, or an isobutyl methacrylate-methylmethacrylate-hydroxyethyl acrylate,
(e) the matrix polymer is composed of particles which are smaller than the particles of the SCC polymer, and
(f) the matrix polymer forms a continuous phase in which the SCC polymer is dispersed in the form of particles.

3. A coated floor according to claim 1 or 2 wherein the solid coating of the Releasable SCC Polymer Composition comprises 30-80%, e.g. 40-70% or 50-60%, of the SCC polymer and 20-70%, for example 30-60% or 40-50%, of the matrix polymer.

4. A coated floor according to any of the preceding claims wherein the Releasable SCC Polymer Composition has a thickness of less than 5 μm, preferably less than 2 μm, e.g. less than 1 μm.

5. A coated floor according to any of the preceding claims wherein the Releasable SCC Polymer Composition directly contacts the flooring substrate, or is separated from the flooring substrate by an intermediate coating comprising a polymeric composition which does not include an SCC polymer.

6. A coated floor according to claim 5 wherein the flooring substrate is a vinyl composition tile.

7. A coated floor according to any of the preceding claims which comprises an exterior coating on top of the solid coating of the Releasable SCC Polymer Composition, the exterior coating comprising one or more coatings of a commercially available flooring finish.

10. A liquid composition comprising (1) an SCC polymer which has an onset of melting temperature, T₀, of at least 27° C. and a peak melting temperature (Tp) of at most 120° C. and (2) a matrix polymer, wherein
(A) the SCC polymer has one or more of the following characteristics
(a) the SCC polymer has a To of at least 10° C., or at least 15° C., or at least 27° C., or at least 35° C., or at least 40° C.
(b) the SCC polymer has a Tp of at most 80° C., preferably at most 60° C., particularly at most 50° C.,
(c) the SCC polymer has a Tp and a T₀, measured in degrees centigrade, such that the value of (Tₚ−T₀) is less than Tₚ^{0.7}, preferably less than 25° C., preferably less than 20° C., particularly less than 15° C.,
(d1) the SCC polymer has a weight average molecular weight of at most 100,000 Da, preferably at most 50,000 Da, particularly at most 20,000 Da, and in some applications less than 10,000 Da,
(d2) some or all of the SCC polymer is cross-linked and has an average molecular weight over 1 million or exists as a gel whose molecular weight is so high that it cannot be measured by chromatography methods,
(e) the SCC polymer has been prepared by an emulsion polymerization process which produces particles having a size of 0.07 to 0.5 μm, particularly 0.1 to 0.25 μm,
(f) the SCC polymer comprises units derived from one or more n-alkyl acrylates or methacrylates in proportions by weight such that the average length of the n-alkyl groups is 16-20, for example 16-18, carbon atoms. the n-alkyl groups for example containing 8-22 carbon atoms, and the polymer for example containing 90 to 98%, e.g. 94 to 97%, by weight of the units derived from one or more n-alkyl acrylates.
(g) the SCC polymer comprises 90-98%, e.g. 94-97%, by weight of units derived from octadecyl acrylate and hexadecyl acrylate, the ratio of octadecyl acrylate to hexadecyl acrylate units being for example 16 to 2.
(h) the SCC polymer contains, for example in amount greater than 1%, for example 1-4%, e.g. 2-4%, or 1-3%, or 1-2%, units derived from (i) a comonomer containing a carboxylic group, e.g. methacrylic acid, and/or (ii) a comonomer containing a hydroxyl group, e.g. hydroxyethyl acrylate, hydroxyethyl methacrylate hydroxypropyl acrylate or hydroxypropyl methacrylate, and
(i) the SCC polymer has a heat of fusion of at least 20 Joules/g; and
(B) the matrix polymer has one or more of the following characteristics:—
(a) the matrix polymer has a minimum film forming temperature (MFFT) which is at most 20° C.,
(b) the matrix polymer has a minimum film forming temperature (MFFT) which is at least 20° C.
(c) the matrix polymer is miscible with water,
(d) the matrix polymer is an acrylic or styrene-acrylic polymer prepared by emulsion polymerization, for example a cross-linked styrene-ethyl hexylacrylate-methacrylic acid polymer, a styrene-butylacrylate-methacrylic acid polymer, a styrene-butylacrylate-methylmethacrylate-methacrylic acid polymer, or an isobutyl methacrylate-methylmethacrylate-hydroxyethyl acrylate polymer,
(e) the matrix polymer is composed of particles which are smaller than the particles of the SCC polymer, and
(f) the matrix polymer forms a continuous phase in which the SCC polymer is dispersed in the form of particles,
wherein the Releasable SCC Polymer Composition makes use of one or more of the improvements (A)-(E) set out above.
